(19) United States
(12) Patent Application Publication
(10) Pub. No.: US 2026/0162592 A1
(43) Pub. Date: Jun. 11, 2026

(54) DISPLAY DEVICE AND METHOD OF DRIVING THE SAME

(71) Applicant: LG Display Co., Ltd., Seoul (KR)

(72) Inventors: Bonghwan KIM, Paju-si (KR); Wooho SONG, Paju-si (KR); Geunhyung IN, Paju-si (KR)

(73) Assignee: LG Display Co., Ltd., Seoul (KR)

(21) Appl. No.: 19/255,833

(22) Filed: Jun. 30, 2025

(30) Foreign Application Priority Data
Dec. 10, 2024 (KR) 10-2024-0182619

(51) Int. Cl. G09G 3/32

(52) U.S. Cl. CPC G09G 3/32; G09G 2310/0275; G09G 2310/08; G09G 2320/0242; G09G 2320/0276; G09G 2330/023; G09G 2330/028

(57) ABSTRACT

A display device and a method of driving the same are discussed. The display device includes a display panel having pixels arranged therein, a power supply unit configured to generate a power voltage based on a power voltage control signal, a gamma voltage generator configured to generate gamma voltages by dividing the voltage between the power voltage and a reference voltage, a data driver configured to convert image data into a data voltages using the gamma voltages and apply the data voltages to the pixels, and a timing controller configured to adjust the power voltage based on at least one of a brightness value corresponding to an externally set brightness mode and a luminance value of the image data, and output the power voltage control signal indicating the voltage value of the adjusted power voltage.

### CROSS-REFERENCE TO RELATED APPLICATION

The present application claims priority to Korean Patent Application No. 10-2024-0182619, filed in the Republic of Korea on Dec. 10, 2024, the entire contents of which is hereby expressly incorporated by reference for all purposes into the present application.

### BACKGROUND

### Technical Field

The present disclosure relates to a display device and a method of driving the same.

### Description of the Related Art

A display device includes a display panel and a driving unit. The display panel includes gate lines, data lines, and pixels. The driving unit includes a gate driver that sequentially applies gate signals to the gate lines and a data driver that applies data voltages to the data lines. The pixels can emit light at a brightness corresponding to the data voltage applied to the corresponding data line in response to the gate signal applied to the corresponding gate line.

The data driver divides the power voltage supplied from the outside to generate gamma voltages corresponding to a plurality of gradations, and uses the gamma voltages to convert the gradation values of image data into data voltages.

The voltage range of the gamma voltages includes a compensation margin considering the degradation of the pixels, and the power voltage is also set higher considering the voltage range of the gamma voltages. However, as the power voltage increases, the power consumption of the display device can increase.

### SUMMARY OF THE DISCLOSURE

It is an object of the embodiments to provide a display device and a method of driving the same capable of adjusting the power voltage based on a brightness value set by a brightness mode.

It is another object of the embodiments to provide a display device and a method of driving the same capable of adjusting the power voltage based on the luminance value of image data.

It is another object of the embodiments to provide a display device and a method of driving the same capable of setting the gamma voltage at the lowest voltage level as the gamma voltage corresponding to low gradation, and setting the gamma voltage at the highest voltage level as the gamma voltage corresponding to high gradation.

It is another object of the embodiments to provide a display device and a method of driving the same capable of fixing the gamma voltage at the lowest voltage level, while adjusting the gamma voltage at the highest voltage level based on the power voltage.

It is still another object of the embodiments to provide a display device and a method of driving the same capable of minimizing current leakage by using an oxide semiconductor thin-film transistor.

A display device according to embodiments of the present disclosure can include a display panel comprising pixels arranged therein, a power supply unit configured to generate a power voltage based on a power voltage control signal, a gamma voltage generator configured to generate gamma voltages by dividing the voltage between the power voltage and a reference voltage, a data driver configured to convert image data into a data voltage using the gamma voltages and apply the data voltage to the pixels, and a timing controller configured to adjust the power voltages based on at least one of a brightness value according to an externally set brightness mode and a luminance value of the image data, and output the power voltage control signal indicating the voltage value of the adjusted power voltage.

According to aspects of the present disclosure, the voltage value of the power voltage can vary in proportion to the brightness value or the luminance value.

According to aspects of the present disclosure, the gamma voltages can include a highest gamma voltage having a highest voltage level corresponding to a highest gradation, and a lowest gamma voltage having a lowest voltage level corresponding to a lowest gradation.

According to aspects of the present disclosure, the display device can further include a storage unit configured to store a plurality of voltage values of the power voltage, each corresponding to one of a plurality of brightness values or a plurality of luminance values.

According to aspects of the present disclosure, the timing controller can be configured to obtain a brightness value or a luminance value from an externally applied control signal or image signal and generate the power voltage control signal based on the voltage value of the power voltage corresponding to the brightness value or the luminance value obtained from the storage unit.

According to aspects of the present disclosure, the gamma voltages can have a voltage range determined between the power voltage and the reference voltage, and the voltage range of the gamma voltages can be varied as the power voltage is varied, and the data voltage can have a voltage range configured to vary according to the voltage range of the gamma voltages.

According to aspects of the present disclosure, the power consumption of the display device can be varied according to the voltage range of the data voltage.

According to aspects of the present disclosure, the power voltage can decrease as the brightness value or the luminance value decrease, and the power consumption of the display device decreases as the power voltage decreases.

According to aspects of the present disclosure, the timing controller can increase the reference voltage based on the brightness value or the luminance value being lower than a preset threshold.

According to aspects of the present disclosure, the gamma voltages can be set differently for each color of the pixels, the gamma voltages for a first pixel of the red color being set higher than the gamma voltages for a second pixel of the green color, and the gamma voltages for a third pixel of the blue color being set higher than the gamma voltages for the first pixel.

According to aspects of the present disclosure, a method of driving a display device includes obtaining a brightness value corresponding to a brightness mode set externally or a luminance value of the image data, varying the power voltage based on the brightness value or the luminance value, generating the gamma voltages by dividing the voltage between the varied power voltage and a reference voltage, generating the data voltage using the gamma voltages, and providing the generated data voltage to the pixels.

According to aspects of the present disclosure, the varying of the power voltage can include varying the voltage value of the power voltage in proportion to the brightness value or the luminance value.

According to aspects of the present disclosure, the generating of the gamma voltages can include generating a highest gamma voltage having a highest voltage level corresponding to a highest gradation, and generating a lowest gamma voltage having a lowest voltage level corresponding to a lowest gradation.

According to aspects of the present disclosure, the method can further include storing a plurality of power voltage values, each corresponding to one of a plurality of brightness values or a plurality of luminance values, wherein the varying of the power voltage can include loading, from a storage unit, a power voltage value corresponding to the brightness value or the luminance value.

According to aspects of the present disclosure, the gamma voltages can have a voltage range determined between the power voltage and the reference voltage, and the voltage range of the gamma voltages can be varied as the power voltage is varied, and the data voltage can have a voltage range configured to vary according to the voltage range of the gamma voltages.

According to aspects of the present disclosure, the power consumption of the display device can be varied according to the voltage range of the data voltage.

According to aspects of the present disclosure, the power voltage can decrease as the brightness value or the luminance value decrease, and the power consumption of the display device decreases as the power voltage decreases.

According to aspects of the present disclosure, the method can further include, prior to the generating of the gamma voltages, increasing the reference voltage based on the brightness value or the luminance value being lower than a preset threshold.

According to aspects of the present disclosure, the gamma voltages can be set differently for each color of the pixels, the gamma voltages for a first pixel of the red color being set higher than the gamma voltages for a second pixel of the green color, and the gamma voltages for a third pixel of the blue color being set higher than the gamma voltages for the first pixel.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram illustrating the configuration of a display device according to one or more embodiments of the present disclosure;

FIG. 2 is a circuit diagram illustrating the configuration of a pixel according to an embodiment of the present disclosure;

FIG. 3 is a timing diagram illustrating the driving method of the pixel shown in FIG. 2;

FIG. 4 is a block diagram illustrating in detail a portion of the display device shown in FIG. 1;

FIG. 5 is a diagram for explaining the relationship between a power voltage and a data voltage;

FIG. 6 is a diagram for explaining changes in a data voltage in response to variations in a power voltage;

FIG. 7 is a diagram for explaining changes in a data voltage at low brightness or low luminance;

FIGS. 8 to 10 are diagrams for explaining changes in a gamma voltage in response to variations in a power voltage;

FIG. 11 is a diagram illustrating in detail the gamma voltage generation unit shown in FIG. 1; and

FIG. 12 is a flowchart illustrating a driving method of a display device according to an embodiment of the present disclosure.

### DETAILED DESCRIPTION OF THE EMBODIMENTS

Hereinafter, embodiments of the present disclosure will be described with reference to accompanying drawings. In the specification, when a component (or area, layer, part, etc.) is mentioned as being “on top of,” “connected to,” or “coupled to” another component, it means that it can be directly connected/coupled to the other component, or a third component can be placed between them.

The same reference numerals refer to the same components. In addition, in the drawings, the thickness, proportions, and dimensions of the components are exaggerated for effective description of the technical content. The expression “and/or” is taken to include one or more combinations that can be defined by associated components.

The terms “first,” “second,” etc. are used to describe various components, but the components should not be limited by these terms. The terms are used only for distinguishing one component from another component. For example, a first component can be referred to as a second component and, similarly, the second component can be referred to as the first component, without departing from the scope of the present disclosure. The singular forms are intended to include the plural forms as well unless the context clearly indicates otherwise.

The terms such as “below,” “lower,” “above,” “upper,” etc. are used to describe the relationship of components depicted in the drawings. The terms are relative concepts and are described based on the direction indicated on the drawing. Further, the term “can” fully encompasses all the meanings and coverages of the term “may” and vice versa.

It will be further understood that the terms “comprises,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

Referring to the drawings, embodiments of the present disclosure will be discussed. All the components of each display device according to all embodiments of the present disclosure are operatively coupled and configured.

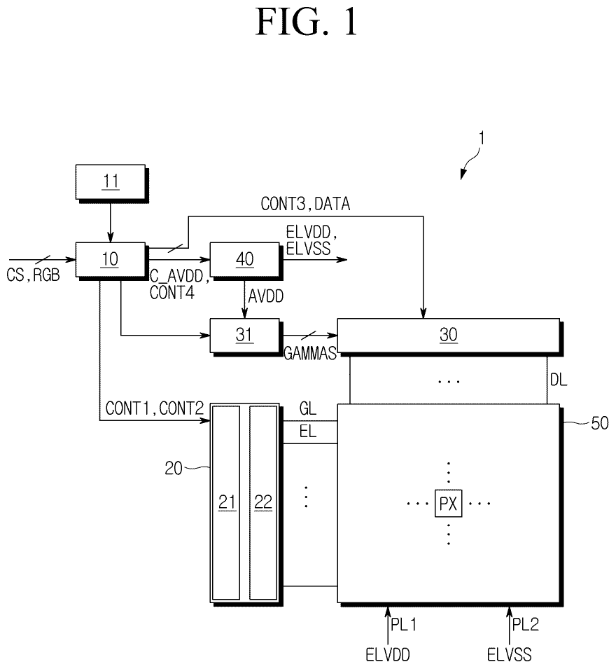

FIG. 1 is a block diagram illustrating the configuration of a display device according to one or more embodiments of the present disclosure.

Referring to FIG. 1, a display device 1 includes a timing controller 10, a storage unit 11, a gate driver 20, a data driver 30, a gamma voltage generation unit 31, a power supply unit 40, and a display panel 50.

The timing controller 10 can receive video signals RGB and control signals CS from external host systems or the like. The video signals RGB can include a plurality of grayscale data. The control signals CS can include a horizontal sync signal, a vertical sync signal, and a main clock signal.

The timing controller 10 can process the video signal RGB and the control signal CS to be suitable for the operating conditions of the display panel 50 and generate and output image data DATA, a scan driving control signal CONT1, a light-emission driving control signal CONT2, a data driving control signal CONT3, and a power supply control signal CONT4.

In an embodiment, the timing controller 10 can adjust the voltage level of the power voltage AVDD based on a brightness mode included in the control signal CS or the like. For example, the timing controller 10 can adjust the voltage value of the power voltage AVDD in response to a brightness value indicated by the control signal CS or the like.

In another embodiment, the timing controller 10 can adjust the voltage level of the power voltage AVDD based on a luminance value of the image data DATA. For example, the timing controller 10 can adjust the voltage value of the power voltage AVDD in response to a peak luminance value or an average luminance value of the image data DATA.

In an embodiment, the timing controller 10 can be configured to directly determine the voltage value of the power voltage AVDD. In another embodiment, the timing controller 10 can be configured to load the voltage value of the power voltage AVDD corresponding to the brightness value and/or the luminance value from a storage unit 11, which will be described later.

The timing controller 10 can generate a power voltage control signal C_AVDD for adjusting the voltage value of the power voltage AVDD to a set voltage value and apply it to a power supply unit 40 or the like.

The storage unit 11 can store voltage levels of the power voltage AVDD corresponding to brightness values set according to a brightness mode or luminance values of the image data DATA. The storage unit 11 can store brightness values and corresponding voltage levels and/or luminance values and corresponding voltage levels in the form of a lookup table. The brightness values can include a plurality of values selected within a range that can be adjusted under the control of a user or a host system. The luminance values can include a plurality of values selected within a luminance range that can be represented by the image data DATA. The lookup table can be provided for each pixel PX, for example, for each color of the pixel PX, but is not limited thereto.

The gate driver 20 can include a scan driving circuit 21 that generates scan signals based on a scan driving control signal CONT1. The scan driving control signal CONT1 can include a start signal, a clock signal, and the like.

The scan driving circuit 21 can provide the generated scan signals to the pixels PX through a plurality of scan lines GL. In an embodiment, a pixel PX can be configured to receive a plurality of scan signals having different waveforms. In this embodiment, the scan driving circuit 21 can provide the plurality of scan signals to the pixels PX through corresponding scan lines GL.

The gate driver 20 can further include a light-emission driving circuit 22 that generates light-emission signals based on a light-emission driving control signal CONT2. The light-emission driving circuit 22 can provide the generated light-emission signals to the pixels PX through emission lines EL.

The gate driver 20 can be configured as a gate in panel (GIP) type mounted on the display panel 50. As illustrated, the gate driver 20 can be disposed on one side of the display panel 50 or on both sides (e.g., left and right sides) of the display panel 50. Depending on the driving method and panel design, the gate driver 20 can be disposed on both sides (e.g., left and right sides) of the display panel 50 or can be connected to two or more of the four sides of the display panel 50.

The gamma voltage generation unit 31 can generate gamma voltages GAMMAS corresponding to a plurality of gradation values based on the power voltage AVDD. The gamma voltage generation unit 31 can include a resistor string (voltage divider circuit) that divides the power voltage AVDD using a plurality of resistors and a decoder that is connected to each node of the resistor string and outputs node voltages as the gamma voltages GAMMAS.

In an embodiment, the power voltage AVDD can be adjusted by an externally input luminance change signal or the like. While the power voltage AVDD is being varied, the voltage range of the gamma voltages GAMMAS generated by the gamma voltage generation unit 31 can also be varied. For example, the gamma voltage corresponding to the maximum gradation value can be adjusted according to the voltage value of the power voltage AVDD. Additionally, the gamma voltages for lower gradation values, which are generated by dividing the power voltage AVDD at a fixed ratio, can also be adjusted in response to the power voltage AVDD.

The data driver 30 can generate data voltages based on the image data DATA and the data driving control signal CONT3 output from the timing controller 10. In this case, the data driver 30 can convert the gradation values included in the image data DATA into corresponding data voltages based on the gamma voltages GAMMAS provided by the gamma voltage generation unit 31. The data driver 30 can supply the generated data voltages to the pixels PX through a plurality of data lines DL.

When the gamma voltages GAMMAS vary according to the power voltage AVDD, the voltage range of the data voltages output from the data driver 30 can also vary. The power consumption of the data driver 30 can be controlled based on the voltage range of the data voltages output from the data driver 30.

The power supply unit 40 can generate high-potential driving voltage ELVDD and low-potential driving voltage ELVSS to be supplied to the display panel 50 based on the power supply control signal CONT4. The power supply unit 40 can supply the generated driving voltages ELVDD and ELVSS to the pixels PX through corresponding power lines PL1 and PL2.

Additionally, the power supply unit 40 can generate a power voltage AVDD based on the power voltage control signal C_AVDD supplied from the timing controller 10. The power voltage AVDD can vary according to the voltage value indicated by the power voltage control signal C_AVDD.

The display panel 50 includes a plurality of pixels PX (or sub-pixels) arranged thereon. The pixels PX can be arranged in a matrix form on the display panel 50, for example. The pixels PX arranged in a row are connected to the same scan line GL and emission line EL, while the pixels PX arranged in a column are connected to the same data line DL. The pixels PX can emit light with a luminance corresponding to the scan signals and data voltages supplied through the scan line GL and data line DL, in response to light-emission signals applied through the emission line EL.

In an embodiment, each pixel PX can display one of the colors, red, green, or blue. In another embodiment, each pixel PX can display one of the colors, cyan, magenta, or yellow. In various embodiments, each pixel PX can display one of the colors, red, green, blue, or white.

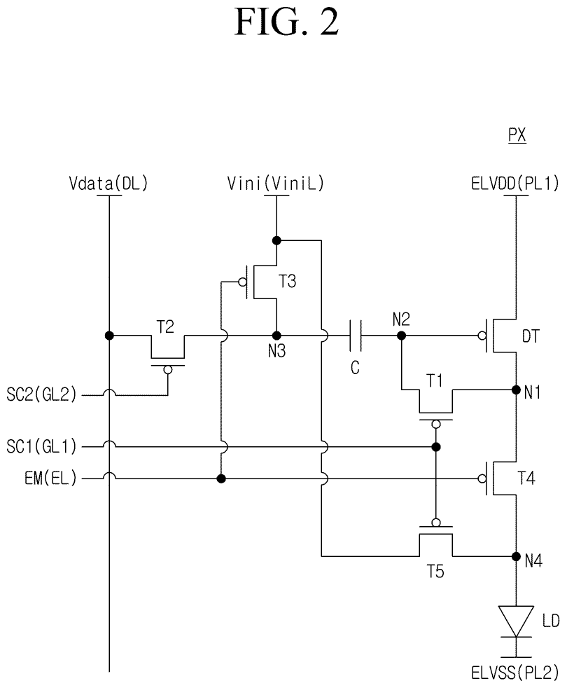

FIG. 2 is a circuit diagram illustrating the configuration of a pixel according to one or more embodiments of the present disclosure.

Referring to FIG. 2, the pixel PX can include a driving transistor DT, a light-emitting element LD connected to the driving transistor DT, and a control circuit for controlling the amount of driving current applied to the light-emitting element LD via the driving transistor DT. For example, the control circuit can include transistors T1 to T5 and a capacitor C.

The first electrode of the driving transistor DT is configured to be supplied with the high-potential driving voltage ELVDD (connected to the high-potential driving voltage line PL1), and the second electrode is connected to the first node N1. The gate electrode of the driving transistor DT is connected to the second node N2. The driving transistor DT can be turned on depending on the voltage applied to the second node N2, controlling the amount of driving current flowing to the light-emitting element LD.

The first electrode of the first transistor T1 is connected to the second electrode of the driving transistor DT through the first node N1, and the second electrode of the first transistor T1 is connected to the gate electrode of the driving transistor DT through the second node N2. The gate electrode of the first transistor T1 is connected to the first scan line GL1 to receive the first scan signal SC1. The first transistor T1 is turned on according to the first scan signal SC1 applied to the first scan line GL1 and stores a voltage corresponding to the threshold voltage of the driving transistor DT. The first transistor T1 can be referred to as a compensation transistor.

The first electrode of the second transistor T2 is connected to the data line DL, and the second electrode is connected to the gate electrode of the driving transistor DT through the third node N3 and the second node N2. The gate electrode of the second transistor T2 is connected to the second scan line GL2 to receive the second scan signal SC2. The second transistor T2 is turned on according to the second scan signal SC2 applied to the second scan line GL2, allowing the data voltage Vdata applied to the data line DL to be transferred to the third node N3. The second transistor T2 can be referred to as a switching transistor.

The first electrode of the third transistor T3 is configured to receive the initialization voltage Vini (connected to the initialization voltage line ViniL), and the second electrode is connected to the gate electrode of the driving transistor DT through the third node N3 and the second node N2. The gate electrode of the third transistor T3 is connected to the emission line EL to receive the light emission signal EM. The third transistor T3 is turned on according to the light emission signal EM applied to the emission line EL, allowing the initialization voltage Vini to be transferred to the third node N3. The third transistor T3 can be referred to as an initialization transistor.

The first electrode of the fourth transistor T4 is connected to the driving transistor DT through the first node N1, and the second electrode is connected to the anode electrode of the light-emitting element LD through the fourth node N4. The gate electrode of the fourth transistor T4 is connected to the emission line EL to receive the light emission signal EM. The fourth transistor T4 can connect the driving transistor DT and the light-emitting element LD in response to the light emission signal EM applied to the emission line EL.

When the fourth transistor T4 is turned on, a current path is formed from the high-potential driving voltage ELVDD to the light-emitting element LD, allowing the driving current to flow through the light-emitting element LD. The light-emitting element LD can emit light with a brightness corresponding to the driving current. The fourth transistor T4 can be referred to as a light-emission transistor.

The first electrode of the fifth transistor T5 is configured to receive the initialization voltage Vini (connected to the initialization voltage line ViniL), and the second electrode is connected to the anode electrode of the light-emitting element LD through the fourth node N4. The gate electrode of the fifth transistor T5 is connected to the first scan line GL1 to receive the first scan signal SC1. The fifth transistor T5 is turned on according to the first scan signal SC1 applied to the first scan line GL1, allowing the initialization voltage Vini to be transmitted to the fourth node N4. The fifth transistor T5 can be referred to as the anode initialization transistor.

The capacitor C is connected between the second node N2 and the third node N3. The capacitor C stores a voltage corresponding to the voltage difference between the second node N2 and the third node N3, and maintains the stored voltage throughout a frame period, stabilizing the voltage at the gate electrode of the driving transistor DT (i.e., the second node N2). This capacitor C can be referred to as a storage capacitor.

The light-emitting element LD can have its anode electrode connected to the fourth node N4 and its cathode electrode connected to the low-potential driving voltage ELVSS. When the driving transistor DT and the fourth transistor T4 are turned on, a current path is formed between the high-potential driving voltage ELVDD and the low-potential driving voltage ELVSS, allowing the driving current to flow through the light-emitting element LD. The light-emitting element LD can emit light with a brightness corresponding to the amount of driving current applied.

In the embodiment of FIG. 2, the pixel PX can include a low temperature poly-silicon (LTPS) thin-film transistor. The LTPS thin-film transistor includes a gate electrode, a source electrode, and a drain electrode. The LTPS thin-film transistor has an active layer made of polysilicon. This LTPS thin-film transistor can be configured as a P-type thin-film transistor. The LTPS thin-film transistor has a high electron mobility, which provides fast driving characteristics. Due to the fast driving characteristics of the LTPS thin-film transistor, the transistors can turn on quickly, resulting in faster response times.

In an embodiment, the pixel PX can further include an oxide semiconductor thin-film transistor, forming a hybrid type. The oxide semiconductor thin-film transistor includes a gate electrode, a source electrode, and a drain electrode. The oxide semiconductor thin-film transistor has an active layer made of oxide semiconductor. Here, the oxide semiconductor can be set as either an amorphous or crystalline oxide semiconductor. The oxide semiconductor thin-film transistor can be configured as an N-type transistor. The oxide semiconductor thin-film transistor can be fabricated using a low-temperature process and has a lower charge mobility compared to the LTPS thin-film transistor. Such an oxide semiconductor thin-film transistor exhibits excellent off-current characteristics.

In an embodiment, the driving transistor DT can be formed as an oxide semiconductor thin-film transistor. At least one of the transistors T1 to T5 can be formed as an oxide semiconductor thin-film transistor.

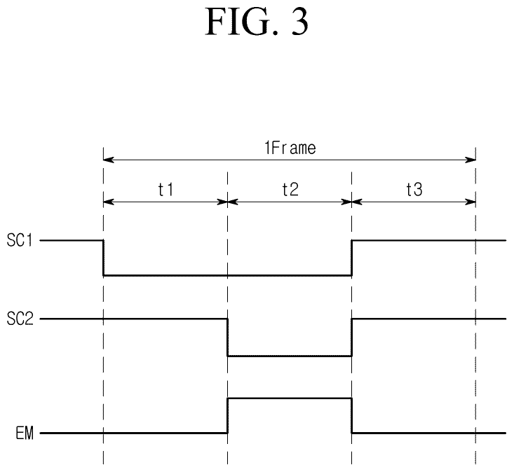

FIG. 3 is a timing diagram illustrating the driving method of the pixel shown in FIG. 2.

Referring to FIGS. 2 and 3, the pixel PX is driven on a frame basis. One frame can include an initialization period t1, a sampling and programming period t2, and a light emission period t3.

During the initialization period t1, the first scan signal SC1 and the light emission signal EM at a turn-on level are applied simultaneously, turning on the first, third, fourth, and fifth transistors T1, T3, T4, and T5. Through the turned-on third transistor T3, the initialization voltage Vini is applied to the gate electrode of the driving transistor DT, and the node voltage can be initialized. Similarly, through the turned-on fifth transistor T5, the initialization voltage Vini is applied to the anode electrode of the light-emitting element LD, and the node voltage can be initialized. The initialization voltage Vini applied to the fourth node N4 is transmitted through the turned-on fourth transistor T4 and the first transistor T1 to the first node N1 and the second node N2, further initializing the voltages at the first node N1 and the second node N2.

During the sampling and programming period t2, the light emission signal EM is switched to a turn-off level, the second scan signal SC2 at a turn-on level is applied, turning off the third and fourth transistors T3 and T4, and turning on the second transistor T2. Through the turned-on second transistor T2, the data voltage Vdata from the data line DL can be applied to the third node N3. The data voltage Vdata can charge the capacitor C and further be applied to the second node N2.

During the sampling and programming period t2, the second electrode of the driving transistor DT is in a floating state, and the gate electrode and second electrode are in a drain follower state connected through the first transistor T1. When the driving transistor DT is turned on by the data voltage Vdata, a source-drain current can flow from the high-potential driving voltage ELVDD to the driving transistor DT. The driving transistor DT can supply source-drain current to the first node N1 until the source-gate voltage reaches the threshold voltage Vth. The voltage of the first node N1 gradually increases from the initialization voltage Vini and can converge to a voltage VDD+Vth, which is the sum of the high-potential driving voltage ELVDD (represented by VDD here) and the threshold voltage Vth. The voltage of the second node N2, connected to the first node N1 through the first transistor T1, can also converge to the voltage VDD+Vth. Thus, the capacitor C can store a voltage corresponding to the difference between the third node N3 and the second node N2, which is VDD+Vth-Vdata.

During the light emission period t3, the first and second scan signals SC1 and SC2 are switched to a turn-off level, and the light emission signal EM is applied at a turn-on level, turning off the first, second, and fifth transistors T1, T2, and T5, while the fourth transistor T4 is turned on.

Through the turned-on fourth transistor T4, a current path from the high-potential driving voltage ELVDD to the light-emitting element LD via the driving transistor DT is formed. As a result, the driving current corresponding to the programmed voltage in the driving transistor DT is provided to the light-emitting element LD to emit light at the corresponding brightness.

Here, the programmed voltage in the driving transistor DT is the voltage programmed in the capacitor C, which is the data voltage Vdata compensated by the threshold voltage Vth. Therefore, the degradation of the driving transistor DT can be compensated.

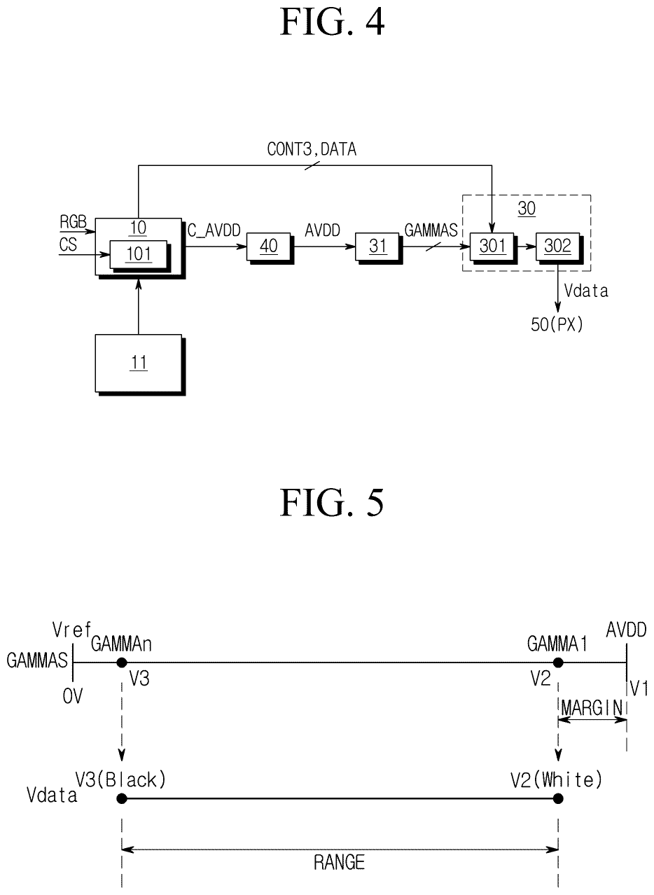

FIG. 4 is a block diagram illustrating in detail a portion of the display device shown in FIG. 1.

Referring to FIG. 4, the storage unit 11 can store voltage levels of the power voltage AVDD corresponding to brightness values set according to the brightness mode or luminance values of the image data DATA. The storage unit 11 can store brightness values and corresponding voltage levels and/or luminance values and corresponding voltage levels in the form of a lookup table. The brightness values can include a plurality of values selected within a range that can be varied under the control of a user or a host system. The luminance values can include a plurality of values selected within a luminance range that can be represented by the image data DATA. The lookup table can be provided for each pixel PX, for example, for each color of the pixel PX, but is not limited thereto.

The storage unit 11 can be composed of a non-volatile memory or a volatile memory. In an embodiment, the storage unit 11 can be formed as a separate component from the timing controller 10, as shown in the drawing, or can be provided within the timing controller 10.

The timing controller 10 can include a power voltage controller 101. The power voltage controller 101 receives a control signal CS including a brightness mode from the outside and sets the voltage value of the power voltage AVDD corresponding to the brightness value indicated by the brightness mode. In another embodiment, the power voltage controller 101 can set the voltage value of the power voltage AVDD based on the maximum luminance value and/or average luminance value of the image data DATA generated from the video signal RGB.

In this case, the voltage value of the power voltage AVDD can be set to be proportional to the brightness value or luminance value. For example, as the brightness or luminance value increases, the voltage value of the power voltage AVDD is set higher, and as the brightness or luminance value decreases, the voltage value of the power voltage AVDD is set lower.

The voltage value of the power voltage AVDD can be set based on the gradation voltage corresponding to the highest gradation and a predetermined margin value. The margin value is set to ensure that the data voltage Vdata can be reliably output from the data driver 30, for example, within about 10% to 15% of the gradation voltage corresponding to the highest gradation, but is not limited to this range. The voltage value of the power voltage AVDD can be set as the maximum gradation voltage corresponding to the brightness or luminance value, with the aforementioned margin value added.

The power voltage controller 101 can directly set the voltage value of the power voltage AVDD or can be configured to load the voltage value from the storage unit 11. The power voltage controller 101 can generate and output a power voltage control signal C_AVDD indicating the set voltage value.

The power supply unit 40 generates a varied power voltage AVDD based on the power voltage control signal C_AVDD applied by the power voltage controller 101. For example, during initial operation, the power supply unit 40 generates a power voltage AVDD at a predetermined voltage value, and when the voltage value of the power voltage AVDD is changed (controlled) by the power voltage control signal C_AVDD, the power supply unit 40 can generate the power voltage AVDD at the changed voltage value.

The gamma voltage generator 31 can generate gamma voltages GAMMAS based on the power voltage AVDD applied from the power supply unit 40. The gamma voltage generator 31 can divide the power voltage AVDD into a plurality of voltages through a resistor string and output each of these voltages as gamma voltages GAMMAS corresponding to each gradation.

In an embodiment, the maximum voltage level of the gamma voltages GAMMAS can correspond to the maximum gradation (e.g., the white gradation). The minimum voltage level of the gamma voltages GAMMAS can correspond to the minimum gradation (e.g., the black gradation).

In an embodiment, when the power voltage AVDD varies, the maximum voltage level of the gamma voltages GAMMAS can also vary. Meanwhile, the minimum voltage level of the gamma voltages GAMMAS can remain fixed. As a result, the voltage range of the gamma voltages GAMMAS can vary in response to changes in the power voltage AVDD.

The data driver 30 can include a decoder 301 (or a digital-to-analog converter) and an output buffer 302. The data driver 30 can further include a shift register and latch.

The decoder 301 can convert, from among the gamma voltages GAMMAS provided by the gamma voltage generator 31, a voltage corresponding to the gradation value of the image data DATA into an analog data voltage Vdata and output the analog data voltage Vdata. The output buffer 302 can buffer the data voltage Vdata output from the decoder 301 and then output the buffered voltage to the data line DL.

The data voltage Vdata output through the data driver 30 is based on the gamma voltages GAMMAS, which are generated based on the power voltage AVDD. Therefore, as the magnitude of the power voltage AVDD varies, the magnitude of the data voltage Vdata output from the data driver 30 can also vary. When the brightness value according to the brightness mode and/or the luminance value of the image data DATA decreases and the power voltage AVDD decreases, the voltage value of the data voltage Vdata output through the data driver 30 for the same gradation also decreases, thus reducing the power consumption of the display device 1.

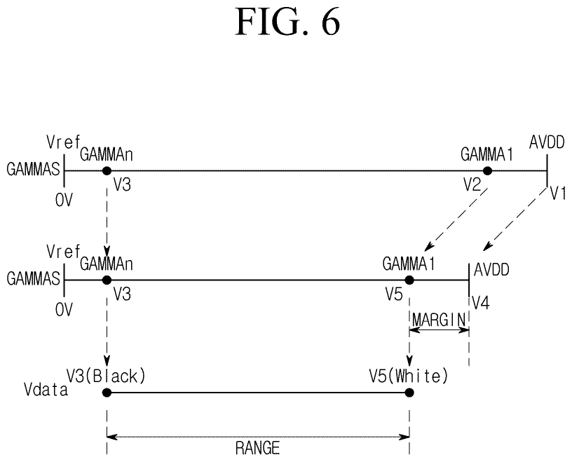

FIG. 5 is a diagram for explaining the relationship between a power voltage and a data voltage.

Referring to FIG. 5, the power voltage AVDD can have a first voltage level V1 according to the power voltage control signal C_AVDD. For example, the first voltage level V1 can be a voltage level obtained by adding a predetermined margin value MARGIN to the maximum value V2 of the gradation voltage. The power voltage AVDD can be set high enough, taking into account various margin values for various display devices 1.

The gamma voltages GAMMAS are generated by dividing the power voltage AVDD and the reference voltage Vref (e.g., ground voltage, 0V). For example, among the gamma voltages GAMMAS, the first gamma voltage GAMMA1 can have the second voltage level V2, and the last gamma voltage, for example, the nth gamma voltage GAMMAn, can have the third voltage level V3. Here, the first gamma voltage GAMMA1 corresponds to the highest gradation, for example, the white gradation, and can have a value equal to or less than the power voltage AVDD. The nth gamma voltage GAMMAn corresponds to the lowest gradation, for example, the black gradation, and can have a value equal to or greater than the reference voltage Vref.

The maximum voltage level of the data voltage Vdata can have the second voltage level V2 corresponding to the highest gamma voltage GAMMA1, and the minimum voltage level can have the third voltage level V3 corresponding to the lowest gamma voltage GAMMAn. For example, depending on the power voltage AVDD and the highest gamma voltage GAMMA1 and the lowest gamma voltage GAMMAn, the voltage range of the data voltage Vdata can be determined between the second voltage level V2 and the third voltage level V3. The power consumption of the data driver 30 and the display device 1 can be determined based on the voltage range of the data voltage Vdata, which is between the second voltage level V2 and the third voltage level V3.

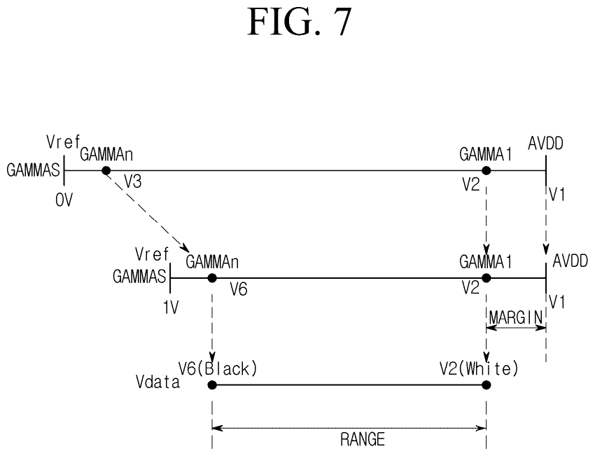

FIG. 6 is a diagram for explaining changes in a data voltage in response to variations in a power voltage.

Referring to FIG. 6, in an embodiment, the power voltage controller 101 can adjust the voltage value of the power voltage AVDD in response to the brightness value of a brightness mode set by a user or other means. For example, when the brightness value increases, the power voltage controller 101 can increase the power voltage AVDD, and when the brightness value decreases, the power voltage controller 101 can decrease the power voltage AVDD. The degree of increase and decrease in the power voltage AVDD can be determined in proportion to the degree of increase and decrease in the brightness value, and its magnitude can be set in various ways.

In another embodiment, the power voltage controller 101 can adjust the voltage value of the power voltage AVDD in response to a luminance value that includes at least one of the peak luminance value and the average luminance value of the image data DATA. For example, when the luminance value increases, the power voltage controller 101 can increase the power voltage AVDD, and when the luminance value decreases, the power voltage controller 101 can decrease the power voltage AVDD. The degree of increase and decrease in the power voltage AVDD can be determined in proportion to the degree of increase and decrease in the brightness value, and its magnitude can be set in various ways.

In the illustrated embodiment, the power voltage controller 101 can output a power voltage control signal C_AVDD to adjust the voltage level of the power voltage AVDD to a fourth voltage level V4. The fourth voltage level V4 can be a voltage level obtained by adding a fixed margin value MARGIN to the maximum value V5 of the gradation voltage.

The gamma voltages GAMMAS are generated by dividing the varied power voltage AVDD and a reference voltage Vref (e.g., ground voltage, 0V). For example, the first gamma voltage GAMMA1 among the gamma voltages GAMMAS can have a fifth voltage level V5, and the last gamma voltage among the gamma voltages GAMMAS, for example, the nth gamma voltage GAMMAn, can have a third voltage level V3. Here, the first gamma voltage GAMMA1 corresponds to the highest gradation, for example, the white gradation, and can have a value equal to or less than the power voltage AVDD. The nth gamma voltage GAMMAn corresponds to the lowest gradation, for example, the black gradation, and can have a value equal to or greater than the reference voltage Vref.

The maximum voltage level of the data voltage Vdata can have a fifth voltage level V5 corresponding to the highest gamma voltage GAMMA1, while the minimum voltage level can have a third voltage level V3 corresponding to the lowest gamma voltage GAMMAn. For example, the voltage range of the data voltage Vdata can be determined between the fifth voltage level V5 and the third voltage level V3, depending on the power voltage AVDD and the highest gamma voltage GAMMA1 and the lowest gamma voltage GAMMAn. The power consumption of the data driver 30 and the display device 1 can be determined based on the voltage range of the data voltage Vdata, which is between the fifth voltage level V5 and the third voltage level V3.

Comparing FIG. 5 and FIG. 6, when the power voltage AVDD varies, the power consumption of the data driver 30 and the display device 1 can also vary. When the power voltage AVDD corresponds to high gradation and the reference voltage Vref corresponds to low gradation, the power voltage AVDD can be reduced when the brightness value and/or luminance value decreases. Accordingly, when the brightness value and/or luminance value decreases, the power consumption of the data driver 30 and the display device 1 can be reduced.

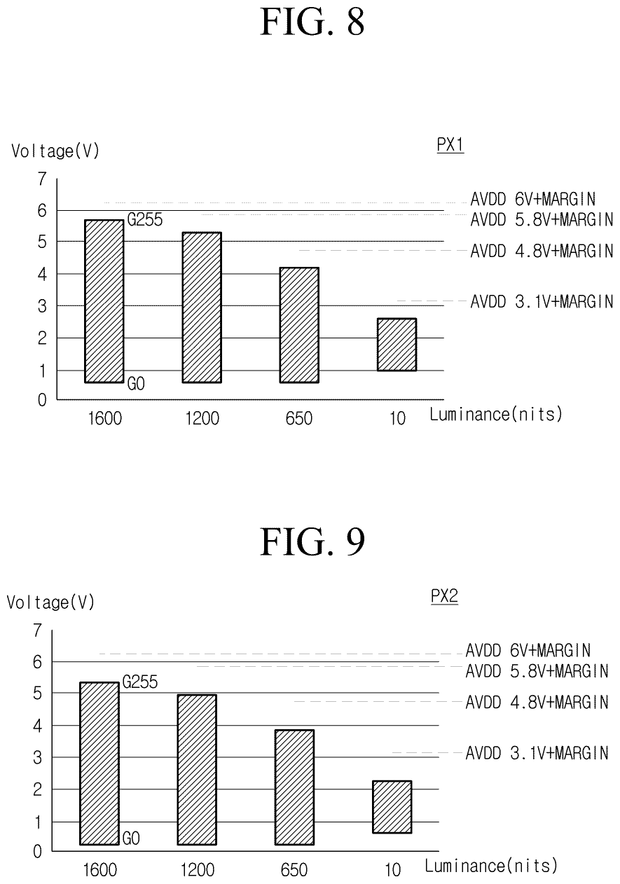

FIG. 7 is a diagram for explaining changes in a data voltage at low brightness or low luminance.

Referring to FIG. 7, when the brightness value according to brightness mode control or the luminance value of the image data DATA is lower than a predetermined threshold, a deterioration in image quality can occur due to luminance crushing. To prevent this issue, in an embodiment, when the brightness value according to brightness mode control or the luminance value of the image data DATA is lower than a predetermined threshold, the reference voltage Vref can be set to a voltage higher than 0V.

The gamma voltages GAMMAS can be generated by dividing the power voltage AVDD and the adjusted reference voltage Vref (e.g., 1V). For example, among the gamma voltages GAMMAS, the first gamma voltage GAMMA1 can have a second voltage level V2, while the last gamma voltage, e.g., the nth gamma voltage GAMMAn, can have a sixth voltage level V6. Here, the first gamma voltage GAMMA1 corresponds to the highest gradation, for example, the white gradation, and can have a value equal to or less than the power voltage AVDD. The nth gamma voltage GAMMAn corresponds to the lowest gradation, for example, the black gradation, and can have a value equal to or greater than the reference voltage Vref.

The maximum voltage level of the data voltage Vdata can have a second voltage level V2 corresponding to the highest gamma voltage GAMMA1, while the minimum voltage level can have a sixth voltage level V6 corresponding to the lowest gamma voltage GAMMAn. For example, depending on the power voltage AVDD and the highest gamma voltage GAMMA1 and the lowest gamma voltage GAMMAn, the voltage range of the data voltage Vdata can be determined between the second voltage level V2 and the sixth voltage level V6.

Since the minimum voltage level of the data voltage Vdata increases by the increment of the reference voltage Vref, luminance crushing in low gradations can be improved.

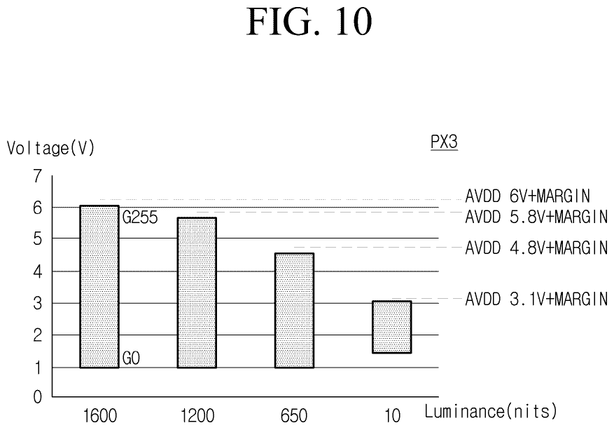

FIGS. 8 to 10 are diagrams for explaining changes in a gamma voltage in response to variations in a power voltage. Specifically, FIGS. 8 to 10 illustrate changes in gamma voltages in response to variations in the power voltage for red, green, and blue pixels PX1, PX2, and PX3, respectively.

Referring to FIG. 8, when the luminance value of the red pixel PX1 is at a first value (e.g., 1600 nits), the power voltage AVDD can be set to a voltage level obtained by adding a predetermined margin value MARGIN to approximately 6V. The gamma voltages GAMMAS can be generated by dividing the voltage between the power voltage AVDD and the reference voltage Vref (0V). Among the gamma voltages GAMMAS, the first gamma voltage GAMMA1 corresponding to the highest gradation (e.g., gradation 255 G255) can be set to a voltage lower than 6V by a predetermined offset, while the nth gamma voltage GAMMAn corresponding to the lowest gradation (e.g., gradation 0 GO) can be set to a voltage higher than the reference voltage Vref by a predetermined offset. The gamma voltages GAMMAS corresponding to the 255 gradations can be generated by dividing the first gamma voltage GAMMA1 and the nth gamma voltage GAMMAn.

When the luminance value is at a second value (e.g., 1200 nits), which is lower than the first value, the power voltage AVDD can be set to a voltage level obtained by adding a predetermined margin value MARGIN to a voltage lower than 6V, e.g., 5.8V. The gamma voltages GAMMAS can be generated by dividing the voltage between the power voltage AVDD and the reference voltage Vref (0V). Among the gamma voltages GAMMAS, the first gamma voltage GAMMA1 corresponding to the highest gradation (e.g., gradation 255 G255) can be set to a voltage lower than 5.8V by a predetermined offset, while the nth gamma voltage GAMMAn corresponding to the lowest gradation (e.g., gradation 0 GO) can be set to a voltage higher than the reference voltage Vref by a predetermined offset. The gamma voltages GAMMAS corresponding to the 255 gradations can be generated by dividing the first gamma voltage GAMMA1 and the nth gamma voltage GAMMAn.

When the luminance value is a second value lower than the first value, the voltage value of the data voltage can also be adjusted, and power consumption can be reduced by decreasing the maximum voltage value and voltage range of the gamma voltages GAMMAS through the power voltage AVDD.

When the luminance value is lower than the second value and reaches a third value (e.g., 650 nit), the power voltage AVDD can be set to a voltage level lower than 5.8V, for example, 4.8V, with a predetermined margin value MARGIN added. The gamma voltages GAMMAS can be generated by dividing the voltage between the power voltage AVDD and the reference voltage Vref (0V). Among the gamma voltages GAMMAS, the first gamma voltage GAMMA1 corresponding to the highest gradation (e.g., gradation 255 G255) can be set to a voltage lower than 4.8V by a predetermined offset, while the nth gamma voltage GAMMAn corresponding to the lowest gradation (e.g., gradation 0 GO) can be set to a voltage higher than the reference voltage Vref by a predetermined offset. The gamma voltages GAMMAS corresponding to the 255 gradations can be generated by dividing the first gamma voltage GAMMA1 and the nth gamma voltage GAMMAn.

When the luminance value reaches a third value lower than the second value, the highest voltage value and voltage range of the gamma voltages GAMMAS can be reduced through the power voltage AVDD, thereby adjusting the data voltage value and reducing power consumption.

When the luminance value falls below the third value and reaches a fourth value (e.g., 10 nits), the power voltage AVDD can be set to a voltage level lower than 4.8V, such as 3.1V, with a predetermined margin value (MARGIN) added. When the luminance value is lower than a predetermined threshold, such as in low-luminance mode or low-luminance images, the reference voltage Vref can be adjusted to a voltage higher than 0V. This helps prevent image degradation caused by blooming in low luminance. The reference voltage Vref can be, for example, 1V, but is not limited to this value.

The gamma voltages GAMMAS can be generated by dividing the voltage between the power voltage AVDD and the reference voltage Vref (1V). Among the gamma voltages GAMMAS, the first gamma voltage GAMMA1 corresponding to the highest gradation (e.g., gradation 255 G255) can be set to a voltage lower than 3.1V by a predetermined offset, while the nth gamma voltage GAMMAn corresponding to the lowest gradation (e.g., gradation 0 GO) can be set to a voltage higher than the reference voltage Vref by a predetermined offset. The gamma voltages GAMMAS corresponding to the 255 gradations can be generated by dividing the first gamma voltage GAMMA1 and the nth gamma voltage GAMMAn.

When the luminance value reaches a fourth value lower than the third value, the highest voltage value and voltage range of the gamma voltages GAMMAS can be reduced through the power voltage AVDD, thereby adjusting the data voltage value and reducing power consumption.

Referring to FIG. 9, in the case of green-colored pixels PX2, the voltage level of the power voltage AVDD also varies according to the luminance value in the same manner as for red-colored pixels PX1. Additionally, in low-brightness images, the reference voltage (Vref) can be further adjusted.

Since the green color has better visibility than the red color, to provide a uniform color appearance to the viewer, the gamma voltages GAMMAS for the green color can be set lower than the gamma voltages GAMMAS for the red color.

Referring to FIG. 10, in the case of blue-colored pixels PX3, the voltage level of the power voltage AVDD also adjusts according to the brightness value in the same manner as for red-colored pixels PX1. Additionally, in low-brightness images, the reference voltage (Vref) can be further adjusted.

Since blue color has worse visibility than red, to provide a uniform color appearance to the viewer, the gamma voltages GAMMAS for the blue color can be set higher than the gamma voltages GAMMAS for the red color.

The method of adjusting the power voltage AVDD for the green and blue-colored pixels PX2 and PX3 is substantially the same as the method described for the red-colored pixels PX1, so a detailed explanation can be omitted.

Although the description of variations of the power voltage and the gamma voltages is performed with respect to the luminance values with reference to FIGS. 8 to 10 in the above, the description is similarly adapted to the brightness value, which is not restrictive and not repeated here again.

Table 1 shows the voltage values of the power voltage AVDD for different luminance levels for an arbitrary gradation, such as gradation 127, the voltage values of the reference voltage Vref, and the color coordinates for each of these voltage values.

TABLE 1

| | | Vref | | | | |
|---|---|---|---|---|---|---|
| Gray | AVDD | REFH | REFL | Wx | Wy | Lv |
| 127 | 7.5 | 5.2 | 0.8 | 0.3452 | 0.3351 | 129.86 |
| | 7 | | | 0.3452 | 0.3351 | 129.89 |
| | 6.5 | | | 0.345 | 0.3352 | 130.12 |
| | 6 | | | 0.3452 | 0.335 | 129.56 |
| | 5.5 | | | 0.3452 | 0.3348 | 129.15 |
| | 5.3 | | | 0.3452 | 0.3348 | 129.11 |

In Table 1, REFH represents the voltage value of the reference voltage Vref at high gradation, while REFL represents the voltage value of the reference voltage Vref at low gradation below a predetermined threshold. Wx, Wy, and Lv represent the color coordinates for red and green color axes, yellow and blue color axes, and luminance, respectively. As shown in Table 1, even when the power voltage AVDD is varied while the reference voltage Vref remains fixed, the luminance and color coordinates do not change, allowing for a reduction in power consumption without degrading image quality.

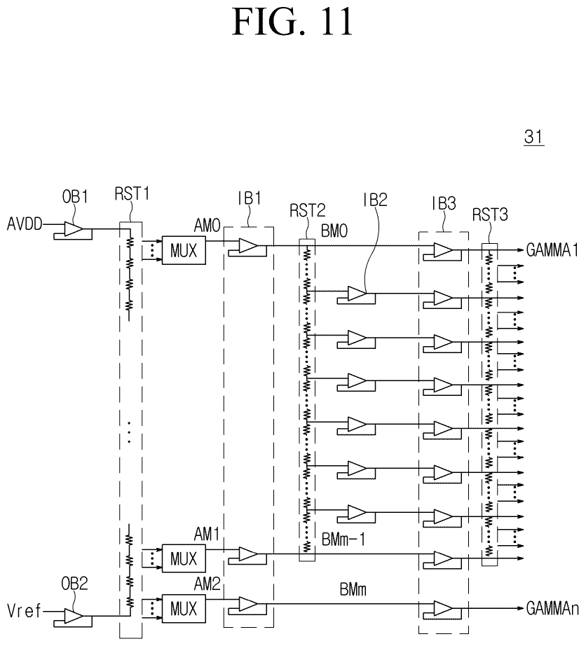

FIG. 11 is a diagram illustrating in detail the gamma voltage generation unit shown in FIG. 1 according to embodiments of the present disclosure.

Referring to FIG. 11, the gamma voltage generator 31 according to an embodiment can include a plurality of resistor strings RST1, RST2, and RST3 and internal buffers IB1, IB2, and IB3 connected between the resistor strings RST1, RST2, and RST3.

Each resistor string RST1, RST2, RST3 is composed of multiple resistors with the same resistance value, allowing for voltage division within the set voltage range.

Specifically, the first resistor string RST1 receives the power voltage AVDD and reference voltage Vref through external buffers OB1, OB2 and can divide the voltage between the power voltage AVDD and reference voltage Vref.

A multiplexer MUX, or decoder, is connected between the first resistor string RST1 and the first internal buffer IB1. The first internal buffer IB1 can be driven by the signal output from the multiplexer MUX. The N-bit multiplexer MUX includes N switches, allowing the voltages divided through the N resistors of the first resistor string RST1 to be output as the first gamma tap voltages AM0, AM1, and AM2. Here, the first gamma tap voltage AM0 corresponds to the highest gradation, and the third gamma tap voltage AM2 corresponds to the lowest gradation.

The first internal buffer IB1 is connected to the top and bottom taps of the second resistor string RST2, allowing the first gamma tap voltages AM0 and AM1 output from the first resistor string RST1 to be applied to the second resistor string RST2.

The second resistor string RST2 can divide the first gamma tap voltages AM0 and AM1, which are input through the first internal buffer IB1. The second internal buffer IB2 can output the voltages divided through the second resistor string RST2 as the second gamma tap voltages BM0 to BMm-1, and the third gamma tap voltage AM2 acts as the second gamma tap voltage BMm. Here, the second-1 gamma tap voltage BM0 corresponds to the highest gradation, and the second-m gamma tap voltage BMm corresponds to the lowest gradation.

The third internal buffer IB3 applies the second gamma tap voltages BM0 to BMm−1, which are output through the second resistor string RST2 and the second internal buffer IB2 and the second gamma tap voltage BMm, to the third resistor string RST3. The third resistor string RST3 divides the second gamma tap voltages BM0 to BMm and can output a plurality of gamma voltages GAMMAS corresponding to respective gradations.

The configuration of the gamma voltage generator 31 shown in FIG. 11 is an example, and the configuration of the gamma voltage generator 31 is not limited to what is shown. In various embodiments, the gamma voltage generator 31 can be configured to include a greater or fewer number of resistor strings and/or internal buffers.

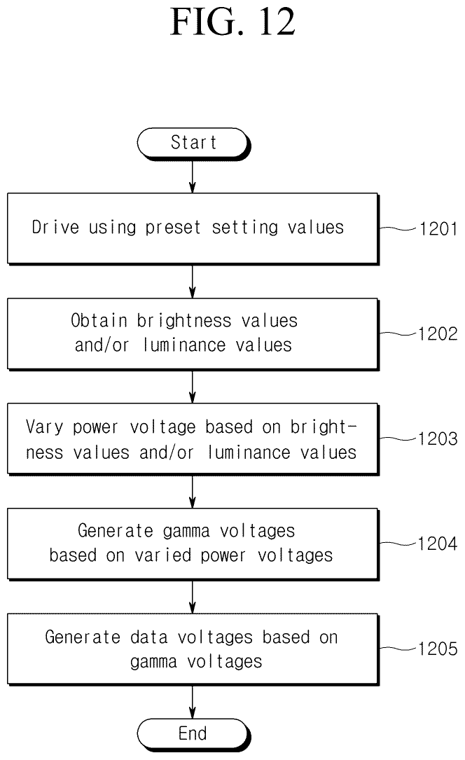

FIG. 12 is a flowchart illustrating a driving method of a display device according to an embodiment.

Referring to FIG. 12, the display device 1 (e.g., FIG. 1) can first be driven using predetermined setting values at operation 1201. These setting values can include the power voltage AVDD, margin value MARGIN, and the like. For example, when the display device 1 is turned on (or initially driven, or when an optical compensation process is performed), the power voltage control unit 101 can control the power supply unit 40 to generate the initial power voltage AVDD based on the look-up table stored in the storage unit 11.

In operation 1202, the display device 1 can obtain a brightness value through adjustments to the brightness mode based on an externally input control signal CS, or obtain a luminance value through image data DATA.

In operation 1203, the display device 1 can then determine the voltage level of the power voltage AVDD corresponding to the obtained brightness value and/or luminance value. For example, the power voltage control unit 101 can increase or decrease the power voltage AVDD in proportion to the brightness value and/or luminance value. Specifically, the power voltage control unit 101 can decide to decrease the power voltage AVDD when the brightness value and/or luminance value decreases, and to increase the power voltage AVDD when the brightness value and/or luminance value increases. In this case, the voltage level of the power voltage AVDD can be determined by a preset value, such as the look-up table stored in the storage unit 11. The power voltage control unit 101 can transmit the power voltage control signal C_AVDD to the power supply unit 40 to generate the varied power voltage AVDD.

In operation 1204, the display device 1 can generate the gamma voltages GAMMAS based on the varied power voltage AVDD. In response to the power voltage control signal C_AVDD, the power supply unit 40 generates the varied power voltage AVDD at the corresponding voltage level and transmits the generated power voltage AVDD to the gamma voltage generator 31. The gamma voltage generator 31 can generate the gamma voltages GAMMAS corresponding to multiple gradations by dividing the voltage between the power voltage AVDD and the reference voltage Vref.

In operation 1205, the display device 1 can convert the image data DATA into the data voltage Vdata using the generated gamma voltages GAMMAS. The data driver 30 can convert the gradation values included in the image data DATA into the corresponding gamma voltages GAMMAS to generate the data voltage Vdata.

The display panel 50 of the display device 1 can display an image according to the generated data voltage Vdata.

A display device and a method of driving the same according to the embodiments of the present disclosure are advantageous for reducing power consumption by setting an optimal power voltage based on a brightness value or a luminance value and adjusting the power voltage accordingly.

A display device and a method of driving the same according to the embodiments of the present disclosure are advantageous for minimizing current leakage by using an oxide semiconductor thin-film transistor.

Although embodiments of this disclosure have been described above with reference to the accompanying drawings, it will be understood that the technical configuration of this disclosure described above can be implemented in other specific forms by those skilled in the art without changing the technical concept or essential features of the present disclosure. Therefore, it should be understood that the embodiments described above are examples and not limited in all respects. Furthermore, the scope of the present disclosure is defined by the appended claims, rather than the detailed description above. In addition, it should be understood that all modifications or variations derived from the meaning and scope of the claims and their equivalent concept are included within the scope of this disclosure.

What is claimed is:

1. A display device comprising:
a display panel comprising pixels arranged therein;
a power supply unit configured to generate a power voltage based on a power voltage control signal;
a gamma voltage generator configured to generate gamma voltages by dividing a voltage between the power voltage and a reference voltage;
a data driver configured to convert image data into a data voltage using the gamma voltages and apply the data voltage to the pixels; and
a timing controller configured to adjust the power voltage based on at least one of a brightness value according to an externally set brightness mode and a luminance value of the image data, and output the power voltage control signal indicating a voltage value of the adjusted power voltage.

2. The display device of claim 1, wherein the voltage value of the power voltage varies in proportion to the brightness value or the luminance value.

3. The display device of claim 1, wherein the gamma voltages comprise:
a highest gamma voltage having a highest voltage level corresponding to a highest gradation, and
a lowest gamma voltage having a lowest voltage level corresponding to a lowest gradation.

4. The display device of claim 1, further comprising a storage unit configured to store a plurality of voltage values of the power voltage, each of the plurality of voltage values of the power voltage corresponding to one of a plurality of brightness values or a plurality of luminance values.

5. The display device of claim 4, wherein the timing controller is configured to obtain a brightness value or a luminance value from an externally applied control signal or image signal and generate the power voltage control signal based on the voltage value of the power voltage corresponding to the brightness value or the luminance value obtained from the storage unit.

6. The display device of claim 1, wherein the gamma voltages have a voltage range determined between the power voltage and the reference voltage,
wherein the voltage range of the gamma voltages is varied as the power voltage is varied, and
wherein the data voltage has a voltage range configured to vary according to the voltage range of the gamma voltages.

7. The display device of claim 6, wherein a power consumption of the display device is varied according to the voltage range of the data voltage.

8. The display device of claim 1, wherein the power voltage decreases as the brightness value or the luminance value decrease, and a power consumption of the display device decreases as the power voltage decreases.

9. The display device of claim 1, wherein the timing controller increases the reference voltage based on the brightness value or the luminance value being lower than a preset threshold.

10. The display device of claim 1, wherein the gamma voltages are set differently for each color of the pixels,
the gamma voltages for a first pixel of a red color being set higher than the gamma voltages for a second pixel of a green color, and
the gamma voltages for a third pixel of a blue color being set higher than the gamma voltages for the first pixel.

11. The display device of claim 3, wherein the highest gamma voltage of the gamma voltages varies while the lowest gamma voltage of the gamma voltages remains fixed when the power voltage varies.

12. The display device of claim 1, wherein each of at least one of the pixels includes a driving transistor, a light-emitting element connected to the driving transistor, and a control circuit configured to control an amount of driving current applied to the light-emitting element via the driving transistor,
wherein the driving transistor is an oxide semiconductor thin-film transistor, and
wherein at least one of a plurality of transistors in the control circuit is an oxide semiconductor thin-film transistor.

13. A method of driving a display device configured to generate gamma voltages based on a power voltage, convert image data into a data voltage using the gamma voltages, and provide the data voltage to pixels, the method comprising:
obtaining a brightness value corresponding to a brightness mode set externally or a luminance value of the image data;
varying the power voltage based on the brightness value or the luminance value;
generating the gamma voltages by dividing a voltage between the varied power voltage and a reference voltage;
generating the data voltage using the gamma voltages; and
providing the generated data voltage to the pixels.

14. The method of claim 13, wherein the varying of the power voltage comprises varying a voltage value of the power voltage in proportion to the brightness value or the luminance value.

15. The method of claim 13, wherein the generating of the gamma voltages comprises:
generating a highest gamma voltage having a highest voltage level corresponding to a highest gradation; and
generating a lowest gamma voltage having a lowest voltage level corresponding to a lowest gradation.

16. The method of claim 13, further comprising storing a plurality of power voltage values, each of the plurality of power voltage values corresponding to one of a plurality of brightness values or a plurality of luminance values,
wherein the varying of the power voltage comprises loading, from a storage unit, a power voltage value corresponding to the brightness value or the luminance value.

17. The method of claim 13, wherein the gamma voltages have a voltage range determined between the power voltage and the reference voltage,
wherein the voltage range of the gamma voltages is varied as the power voltage is varied, and
wherein the data voltage has a voltage range configured to vary according to the voltage range of the gamma voltages.

18. The method of claim 13, wherein the power voltage decreases as the brightness value or the luminance value decrease, and a power consumption of the display device decreases as the power voltage decreases.

19. The method of claim 18, further comprising, prior to the generating of the gamma voltages, increasing the reference voltage based on the brightness value or the luminance value being lower than a preset threshold.

20. The method of claim 13, wherein the gamma voltages are set differently for each color of the pixels,
wherein the gamma voltages for a first pixel of a red color are set higher than the gamma voltages for a second pixel of a green color, and
wherein the gamma voltages for a third pixel of a blue color are set higher than the gamma voltages for the first pixel.
